(19) United States
(12) Patent Application Publication
(10) Pub. No.: US 2006/0188267 A1
(43) Pub. Date: Aug. 24, 2006

(54) System and method for suppression of stimulated Brillouin scattering in optical transmission communications

(76) Inventors: Pavle Gavrilovic, Allen, TX (US); Peter J. Goudreau, Garland, TX (US); William Burkett, Park Ridge, IL (US)

Correspondence Address: BAKER BOTTS L.L.P., 2001 ROSS AVENUE, SUITE 600, DALLAS, TX, 75201-2980, US

(21) Appl. No.: 11/067,418

(22) Filed: Feb. 23, 2005

(51) Int. Cl. H04B 10/04

(52) U.S. Cl. 398/188

(57) ABSTRACT

An optical transmitter includes a light source and an SBS suppression circuit coupled to the light source. The light source is operable to generate an optical signal having one or more wavelengths. The optical signal has a signal spectrum having an upper band limit and a lower band limit. The SBS suppression circuit is operable to communicate a noise current for receipt by the light source. The noise current is operable to broaden the signal spectrum of the optical signal. The light source operates to convert the noise current into a noise component of the signal spectrum that resides between the upper band limit and the lower band limit.

### TECHNICAL FIELD OF THE INVENTION

This invention relates in general to the field of communication systems and, more particularly, to a system and method for suppression of stimulated Brillouin scattering in optical communications.

### BACKGROUND OF THE INVENTION

The nonlinear phenomenon known as stimulated Brillouin scattering (SBS) is an impairment in fiber-optic transmissions. The phenomenon may generally be described in the following manner. When an incident wave propagating along an optical fiber reaches a threshold power, an acoustic wave within the fiber may become excited and alter the refractive index of the fiber. The fluctuation in the refractive index may in turn scatter the incident wave, creating a reflected wave that propagates in the opposite direction—in some instances interfering with the incident wave. This scattering is commonly referred to as Brillouin scattering. Since the scattering effect is caused by the incident light wave, the process is known as stimulated Brillouin scattering (SBS).

Conventional techniques directed towards reducing the affects of SBS may include directly modulating a laser and applying additional modulations on the modulator. Problems arising with these techniques include, among others, a potential increase in the error rate for the optical signals. For example, in some configurations, an unacceptable error rate may be on the order of ½ dBQ.

### SUMMARY OF THE DISCLOSURE

According to one embodiment of the present disclosure, an optical transmitter comprises a light source and an SBS suppression circuit coupled to the light source. The light source is operable to generate an optical signal having one or more wavelengths. The optical signal comprises a signal spectrum having an upper band limit and a lower band limit. The SBS suppression circuit is operable to communicate a noise current for receipt by the light source. The noise current is operable to broaden the signal spectrum of the optical signal. The light source operates to convert the noise current into a noise component of the signal spectrum that resides between the upper band limit and the lower band limit.

Depending on the specific features implemented, particular embodiments of the present disclosure may exhibit some, none, or all of the following technical advantages. Various embodiments may be capable of reducing effects of SBS by increasing a power threshold by broadening a line-width of an optical signal. Other technical advantages of other embodiments may include the capability to broaden the line-width of an optically transmitted signal while reducing errors that may be introduced as a result of such line-width broadening.

Although specific advantages have been enumerated above, various embodiments may include some, none, or all of the enumerated technical advantages. Additionally, other technical advantages may become readily apparent to one of ordinary skill in the art after review of the following figures, description, and claims.

### BRIEF DESCRIPTION OF THE DRAWINGS

To provide a more complete understanding of the present invention and features and advantages thereof, reference is made to the following description, taken in conjunction with the accompanying figures, wherein like reference numerals represent like parts, in which:

FIG. 1 is a block diagram showing at least a portion of an optical communication system operable to facilitate communication of one or more multiple wavelength signals;

FIG. 2 is a block diagram of a transmitter that includes an SBS suppression circuit that is capable of broadening the line-width of a light source;

FIG. 3 is a block diagram of an embodiment of an SBS suppression circuit that may be utilized to generate a noise component of a signal;

FIG. 4 is a graph comparing output spectrums of a light source while the light source is receiving a noise current from an SBS suppression circuit and while the light source is not receiving such noise current; and

FIG. 5 is a flow chart showing one example of a method of broadening a line-width of a light source by combining a noise current with a drive current.

### DETAILED DESCRIPTION OF EXAMPLE EMBODIMENTS

It should be understood at the outset that although example implementations of embodiments of the disclosure are illustrated below, the present disclosure may be implemented using any number of techniques, whether currently known or in existence. The present disclosure should in no way be limited to the example implementations, drawings, and techniques illustrated below. Additionally, the drawings are not necessarily drawn to scale.

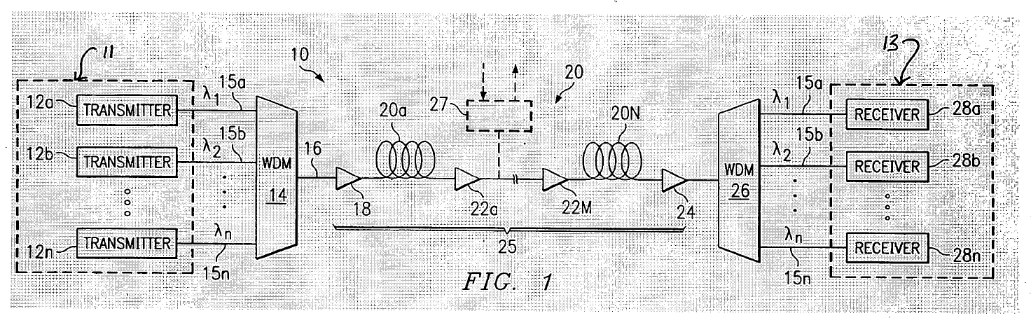

FIG. 1 is a block diagram showing at least a portion of an optical communication system 10 operable to facilitate communication of one or more multiple wavelength signals 16. Each multiple wavelength signal 16 comprises a plurality of optical wavelength signals (or channels) 15a-15n, each comprising a center wavelength of light. In some embodiments, each optical signal 15a-15n comprises a center wavelength that is substantially different from the center wavelengths of other signals 15. As used throughout this document, the term “center wavelength” refers to a time-averaged mean of the spectral distribution of an optical signal. The spectrum surrounding the center wavelength need not be symmetric about the center wavelength. Moreover, there is no requirement that the center wavelength represent a carrier wavelength.

In this example, system 10 includes a plurality of transmitters 12a-12n operable to generate the plurality of optical signals (or channels) 15a-15n. Transmitters 12 can comprise any device capable of generating one or more optical signals. Transmitters 12 can comprise externally modulated light sources, or can comprise directly modulated light sources.

In one embodiment, transmitters 12 comprise a plurality of independent light sources each having an associated modulator, with each source being operable to generate one or more wavelength signals 15. Alternatively, transmitter 12 could comprise one or more light sources shared by a plurality of modulators. For example, transmitter 12 could comprise a continuum source transmitter including a mode-locked source operable to generate a series of optical pulses and a continuum generator operable to receive a train of pulses from the mode-locked source and to spectrally broaden the pulses to form an approximate spectral continuum of optical signals. In that embodiment, a signal splitter receives the continuum and separates the continuum into individual signals each having a center wavelength. In some embodiments, transmitter 12 can also include a pulse rate multiplexer, such as a time division multiplexer, operable to multiplex pulses received from the mode locked source or the modulator to increase the bit rate of the system.

The transmitter 12 in some embodiments may incorporate a bandpass noise source that is capable of generating a noise component that is at least partially within the signal band of an optical signal generated by the light source. In other embodiments, the transmitter 12 may incorporate a bandpass noise source that is capable of generating a noise component that is entirely within the signal band of the optical signal generated by the light source. In yet further embodiments, the transmitter 12 may incorporate a bandpass noise source that is capable of generating a noise component that is entirely outside the signal band of the optical signal generated by the light source. In various embodiments, the noise component generated by the bandpass noise source may be capable of broadening the line-width of the light source.

Transmitter 12, in some cases, may comprise a portion of an optical regenerator. That is, transmitter 12 may generate optical signals 15 based on electrical representations of electrical or optical signals received from other optical communication links. In other cases, transmitter 12 may generate optical signals 15 based on information received from sources residing locally to transmitters 12. Transmitter 12 could also comprise a portion of a transponder assembly (not explicitly shown), containing a plurality of transmitters and a plurality of receivers.

In the illustrated embodiment, system 10 also includes a combiner 14 operable to receive wavelength signals 15a-15n and to combine those signals into a multiple wavelength signal 16. As one particular example, combiner 14 could comprise a wavelength division multiplexer (WDM). The terms wavelength division multiplexer and wavelength division demultiplexer as used herein may include equipment operable to process wavelength division multiplexed signals and/or equipment operable to process dense wavelength division multiplexed signals.

System 10 communicates multiple wavelength signal 16 over an optical communication medium 20. Communication medium 20 can comprise a plurality of spans 20a-20n of fiber. Fiber spans 20a-20n could comprise standard single mode fiber (SMF), dispersion shifted fiber (DSF), non zero dispersion shifted fiber (NZDSF), dispersion compensating fiber (DCF), or another fiber type or combination of fiber types.

Two or more spans of communication medium 20 can collectively form an optical link 25. In the illustrated example, communication medium 20 includes a single optical link 25 comprising numerous spans 20a-20n. System 10 could include any number of additional links coupled to link 25. For example, optical link 25 could comprise one optical link of a multiple link system, where each link is coupled to other links through, for example, optical regenerators.

Optical communication link 25 could comprise, for example, a unidirectional link or a bi-directional link. Link 25 could comprise a point-to-point communication link, or could comprise a portion of a larger communication network, such as a ring network, a mesh network, a star network, or any other network configuration.

System 10 may further include one or more access elements 27. For example, access element 27 could comprise an add/drop multiplexer, a cross connect, or another device operable to terminate, cross connect, switch, route, process, and/or provide access to and from optical link 25 and another optical link or communication device. System 10 may also include one or more lossy elements (not explicitly shown) and/or gain elements capable of at least partially compensating for the lossy element coupled between spans 20 of link 25. For example, the lossy element could comprise a signal separator, a signal combiner, an isolator, a dispersion compensating element, a circulator, or a gain equalizer.

In this embodiment, a separator 26 separates individual optical signal 15a-15n from multiple wavelength signal 16 received at the end of link 25. Separator 26 may comprise, for example, a wavelength division demultiplexer (WDM). Separator 26 communicates individual signal wavelengths or ranges of wavelengths to a bank of receivers 28 and/or other optical communication paths. One or more of receivers 28 may comprise a portion of an optical transceiver operable to receive and convert signals between optical and electrical formats.

System 10 includes a plurality of optical amplifiers coupled to communication medium 20. In this example, system 10 includes a booster amplifier 18 operable to receive and amplify wavelengths of signal 16 in preparation for transmission over a communication medium 20. Where communication system 10 includes a plurality of fiber spans 20a-20n, system 10 can also include one or more in line amplifiers 22a-22m. In line amplifiers 22 couple to one or more spans 20a-20n and operate to amplify signal 16 as it traverses communication medium 20. The illustrated example also implements a preamplifier 24 operable to amplify signal 16 received from a final fiber span 20n prior to communicating signal 16 to separator 26. Although optical link 25 is shown to include one or more booster amplifiers 18 and preamplifiers 24, one or more of the amplifier types could be eliminated in other embodiments.

Amplifiers 18, 22, and 24 could each comprise, for example, one or more stages of discrete Raman amplification stages, distributed Raman amplification stages, rare earth doped amplification stages, such as erbium doped or thulium doped stages, semiconductor amplification stages or a combination of these or other amplification stage types. In some embodiments, amplifiers 18, 22, and 24 could each comprise bi-directional Raman amplifiers. Throughout this document, the term “amplifier” denotes a device or combination of devices operable to at least partially compensate for at least some of the losses incurred by signals while traversing all or a portion of optical link 25. Likewise, the terms “amplify” and “amplification” refer to offsetting at least a portion of losses that would otherwise be incurred.

An amplifier may, or may not impart a net gain to a signal being amplified. Moreover, the terms “gain” and “amplify” as used throughout this document do not (unless explicitly specified) require a net gain. In other words, it is not necessary that a signal experiencing “gain” or “amplification” in an amplifier stage experience enough gain to overcome all losses in the amplifier stage or in the fiber connected to the amplifier stage. As a specific example, distributed Raman amplifier stages typically do not experience enough gain to offset all of the losses in the transmission fiber that serves as a gain medium. Nevertheless, these devices are considered “amplifiers” because they offset at least a portion of the losses experienced in the transmission fiber.

Depending on the amplifier types chosen, one or more of amplifiers 18, 22, and/or 24 could comprise a wide band amplifier operable to amplify all signal wavelengths 15a-15n received. Alternatively, one or more of those amplifiers could comprise a parallel combination of narrower band amplifier assemblies, wherein each amplifier in the parallel combination is operable to amplify a portion of the wavelengths of multiple wavelength signal 16. In that case, system 10 could incorporate signal separators and/or signal combiners surrounding the parallel combinations of amplifier assemblies to facilitate amplification of a plurality of groups of wavelengths for separating and/or combining or recombining the wavelengths for communication through system 10.

In the illustrated embodiment, transmitters 12 and receivers 28 reside within a first terminal 11 and a second terminal 13, respectively. Although in this example terminals 11 and 13 include transmitters 12 and receivers 28, respectively, terminals 11 and 13 can include both transmitters and receivers without departing from the scope of the present disclosure. Additionally, terminals 11 and 13 may include any other optical component, such as, combiner 14, booster amplifier 18, pre-amplifier 24, and/or separator 26 without departing from the scope of the present disclosure. In some cases, terminals 11 and 13 can be referred to as end terminals. The phrase “end terminal” refers to devices operable to perform optical-to-electrical and/or electrical-to-optical signal conversion and/or generation.

In this particular embodiment, terminal 11 includes one or more stimulated Brillouin scattering (SBS) suppression circuits capable of at least partially mitigating at least some of the affects of SBS. SBS is a non-linear effect that can have a detrimental impact on the communication of multiple wavelength optical signals through an optical communication system. When an incident wave propagating along an optical fiber reaches a threshold power, an acoustic wave within the fiber may become excited and alter at least one of the optical properties of the fiber, such as, for example, the refractive index. The fluctuation in the refractive index may in turn scatter the incident wave, creating a reflected wave that propagates in the opposite direction. In some cases, the reflected wave can interfere with and degrade the incident wave. Thus, SBS in an optical fiber is characterized by the efficient transfer of optical power from an optical signal propagating in one direction (e.g., an incident wave) to an optical signal propagating in the opposite direction (e.g., a reflected wave). In most cases, Brillouin scattering effects can limit the maximum launch power of the multiple wavelength optical signals and lead to interference within the wavelengths associated with the multiple wavelength signals.

SBS typically occurs when the optical power launched into an optical fiber exceeds a threshold power level for each process. The threshold power level is the launched optical signal power level of a light source of a transmitter (e.g., transmitter 12) at which the power level of SBS begins to increase rapidly as a function of the optical signal power. Thus, for a given length of fiber, gradually increasing the launched pump power above the threshold power will lead to rapid increases in the power level associated with SBS. The maximum launch power becomes clamped and excess power is reflected back as SBS. As a result, the amount of optical power received at the end of a span 20 no longer increases linearly with the input power. Consequently, SBS limits the maximum optical power that can be launched into an optical fiber since substantially all of the pump power above the SBS threshold power level operates to increase the power associated with the SBS signal.

The threshold power level is based at least in part on the line-width of the light source in transmitters 12 and the type of fiber implemented in spans 20. One aspect of this disclosure recognizes that implementing an SBS suppression circuit in system 10 can broaden the line-width of the light source in transmitters 12. Broadening the line-width of the light source in transmitters 12 can advantageously increase the threshold power level and minimize the impact of SBS on system 10. Consequently, system 10 can communicate optical signals 15 at higher power levels without experiencing a significant level of SBS. Moreover, implementing the SBS suppression circuit can advantageously improve the error rate of optical signals 15 communicated through system 10.

The SBS suppression circuit can broaden the line-width of the optical source by generating a noise current that the light source converts into a noise component of optical signal 15. In some embodiments, the noise component can occupy at least a portion of the signal band. In other embodiments, the noise component can be entirely within the signal of the optical signal generated by the light source. In either case, the noise component can operate to broaden the line-width or signal spectrum of the light source by, for example, 200 MHz, or more, 300 MHz or more, 1 GHz or more, or 10 GHz or more.

For wideband, high channel count systems (e.g., systems having 60, 100, 150, 200, or 250 channels or wavelengths), there may additionally be a large amount of signal-signal crosstalk due to stimulated Raman scattering (SRS). In some cases, periodic dithering may result in the longer wavelength channels acquiring power from the shorter-wavelength channels, which can build up to high levels over typical long-haul and ultra-long-haul transmission distances (500-2000 km). Even with a different frequency used for each channel, there still may be a possibility for beating between dither tones, which can lead to large modulation depths and additional transmission penalties. With embodiments of the disclosure, the noise component created by the SBS suppression circuit in each channel may be uncorrelated and, therefore, may not significantly increase the interaction between the shorter wavelength signals and the longer wavelengths signals through SBS.

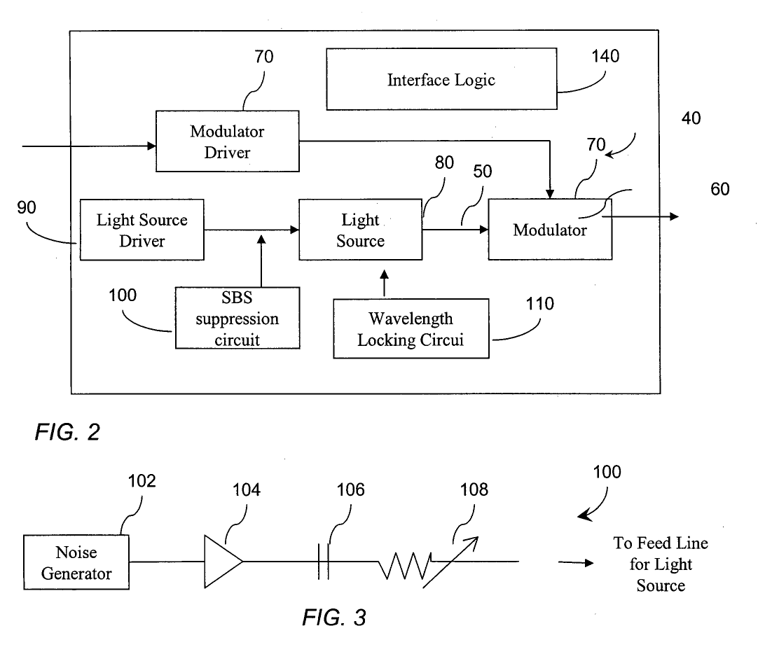

FIG. 2 is a block diagram of a transmitter 40 that includes an SBS suppression circuit 100 that is capable of broadening the line-width of a light source 80. In various embodiments, the structure and function of transmitter 40 can be substantially similar to the structure and function of transmitter 12 of FIG. 1. Transmitter 40 includes a modulator 70 that is operable to encode information onto a carrier optical signal 50 to form an optical signal 60. Modulator 70 could comprise, for example, a lithium-niobate modulator (LiNbO3), an electro-absorption modulator, a gallium arsenide modulator, or any other modulator capable of encoding information onto signal 50.

In some embodiments, transmitter 40 may include an on/off keying (OOK) module (not explicitly shown) capable of encoding an OOK sequence onto signal 50. An advantage of OOK as opposed to analog modulation formats is that the former may be more resistant to amplitude noise. In other embodiments, transmitter 40 may include a forward error correction (FEC) module (not explicitly shown) capable of encoding a FEC sequence onto signal 50. In those embodiments, the FEC sequence encoded onto signal 50 may comprise any sequence capable of improving the Q-factor of signal 60. For example, the FEC sequence may comprise Reed Solomon coding, Turbo Product Codes coding, Concatenated Reed-Solomon coding, or other algorithms capable of improving the Q-factor of modulator 70 and/or the bit error rate of system 10.

Transmitter 40 also includes light source 80 that is operable to generate carrier optical signal 50. Light source 80 could comprise, for example, a laser diode, a distributed feedback laser, or another light source capable of generating carrier optical signal 50. In this example, light source 80 comprises a continuous wave (CW) distributed feedback laser (DFB) operable to generate carrier optical signal 50 having an approximately constant wavelength. In other embodiments, light source 80 may be capable of encoding information directly onto carrier optical signal 50. In various embodiments, modulator 70 and light source 80 could be located on a common substrate.

In this example, transmitter 40 includes a wavelength locking circuit 110 capable of locking light source 80 onto a specific wavelength. Locking circuit 110 can comprise any hardware, software, firmware, or combination thereof, capable of locking light source 80 onto a specific wavelength. Transmitter 40 also includes a light source driver 90 operable to provide a drive current that powers light source 80. Light source driver 90 can comprise any hardware, software, firmware, or combination thereof, capable of providing the drive current to light source 80. In various embodiments, driver 90 may be connected to a suitable power source (not explicitly shown). While not explicitly shown, any of a variety of filters may be in communication with driver 90 and/or light source 80 to facilitate generation of carrier optical signal 50. For example, a filter such as a band pass filter may be utilized, among other things, to filter certain frequencies.

In this particular embodiment, transmitter 40 includes an SBS suppression circuit 100 that is coupled to the output of light source driver 90 and operable to manipulate the drive current communicated to light source 80 by combining a noise current and the drive current. For example, in some embodiments, the noise current may be combined with a DC drive current that is communicated from the light source driver 90. SBS suppression circuit 100 can comprise any hardware, software, firmware, or combination thereof, capable of manipulating the drive current communicated to light source 80. To facilitate the addition of the noise current to the drive current, any of a variety of devices may be utilized. For example, SBS circuit 100 may include devices capable of, matching phases, frequencies, or the like.

In this particular embodiment, SBS circuit 100 operates to manipulate the current received by light source 80. In some cases, circuit 100 can manipulate the current received by light source 80 by combining the noise current and the drive current. In these cases, the noise current can comprise an AC current having a Gaussian distribution with a plurality of peaks and valleys. The noise current may change the power supplied to the light source 80, for example, by moving the power up in the presence of a peak in the noise current and moving the power down in the presence of a valley in the noise current. Thus, the extra noise current can operate to change the power supplied to light source 80 and to create a noise component in carrier signal 50. The noise component, in turn, may broaden the line-width or signal spectrum of carrier signal 50 and increase the threshold power level of transmitter 40. In various embodiments, light source 80 may convert the noise current into a noise component that at least partially resides within the signal band of carrier signal 50.

In this particular embodiment, the noise current communicated to light source 80 operates to produce both amplitude modulation and phase modulation in carrier signal 50. In this example, the noise current communicated from SBS suppression circuit 100 operates to cause light source 80 to produce a line-width or signal spectrum of 300 MHz or more. In other embodiments, SBS suppression circuit 100 may operate to cause light source 80 to produce a line-width or signal spectrum of, for example, 50 MHz or more, 200 MHz or more, 500 MHz or more, or 10 GHz or more. In some cases, the noise current can comprise, for example, a 0.1%, 0.5%, 1.0% or more point-to-point current modulation.

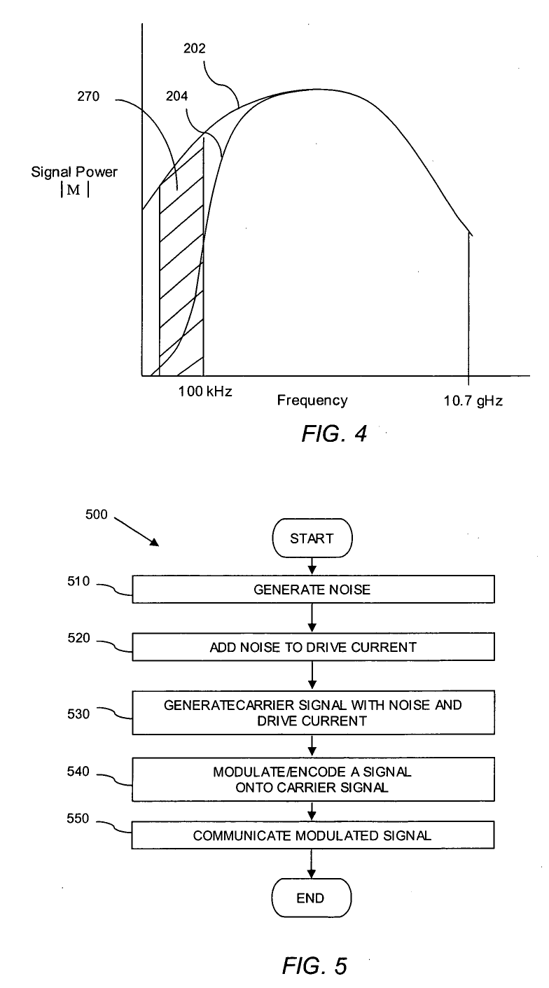

To achieve suitable line-widths, the broadening techniques disclosed herein may be used in conjunction with other line-width broadening techniques. A low residual amplitude modulation may in some embodiments minimize transmission penalties due to eye closure cause by the source dither. Further details of the SBS suppression circuit 100 are described below with reference to FIGS. 3 and 4.

Transmitter 40 also includes an interface logic unit 140 that may be capable of manipulating various operating parameters of transmitter 40. Interface logic unit 140 can comprise any hardware, software, firmware, or combination thereof, capable of manipulating various operating parameters of transmitter 40. In some embodiments, interface logic unit 140 may be integrated with other component parts of the communication system 10 to form a control system. As an example of controlling a parameter of transmitter 40 with interface logic unit 140, an operator may seek to broaden a line-width of light source 80. Accordingly, the operator may initiate an automatic manipulation of one or more components of SBS suppression circuit 100 (e.g., a variable resistor may be manipulated) to achieve the desired line-width.

As part of the control system, interface logic unit 140 may be incorporated into a dynamic feedback system, which may receive input (e.g., feedback) from the component parts of transmitter 40 and/or communication system 10, and, based at least in part upon one or more parameters, adjust the component parts of transmitter 40 and/or communication system 10. As an example of such a dynamic feedback system, an operator may seek particular line-widths to operate during one or more time intervals (e.g., specific times of the week or day). The system, including interface logic unit 140, may communicate and/or manipulate parameters of one or more components of transmitter 40, communication system 10, or both to achieve these line-widths for each time interval. When a specific time interval designates a different line-width, the dynamic feedback system may measure the line-width while changes to the transmitter 40 and/or communication system 10 are being made. Once the desired line-width is achieved, the changes may stop.

FIG. 3 is a block diagram of an embodiment of an SBS suppression circuit 100 that may be utilized to generate a noise current. In this example, SBS suppression circuit 100 includes a noise generator 102 capable of generating a noise current. The noise generator 102 may comprise, for example, a p/n junction to generate thermal noise, a pseudorandom bit sequence (PRBS) generator to generate noise modulation current, or any other suitable noise generators, or combinations thereof. In this particular embodiment, the current generated by noise generator 102 comprises a Gaussian distribution that is characteristic of thermal noise. Although the noise current derives from thermal noise in this example, this noise current may comprise any other suitable distribution without departing from the scope of the present disclosure.

The SBS suppression circuit 100 also includes a voltage amplification unit 104. The voltage amplification unit 104 may comprise any electrical amplifier capable of amplifying the noise current. In this example, the SBS suppression circuit 100 also includes a capacitor 106 that constitutes a high-pass filter, selectively attenuating the lower-frequency components of the current generated by noise generator 102. As one particular example, the capacitor 106 may have a capacitance of 0.1 μF. Although a 0.1 μF capacitor is used in this example, a wide range of values may be used without departing from the scope of the present disclosure.

SBS suppression circuit 100 may further include a variable resistor 108 that is operable to vary the amount of noise current communicated to a light source (e.g., light source 80 of FIG. 2). Varying the noise current provided to light source can operate to vary the line width generated by the light source. Variable resistor 108 may be capable of varying its resistance between, for example, 100Ω to 1 kΩ. Although resistor 108 can vary between 100Ω to 1 kΩ in this example, any other resistance range can be used without departing from the scope of the present disclosure.

In this example, SBS suppression circuit 100 operates to create a noise current that is combined with the low-noise drive current from a current driver (e.g., driver 90 of FIG. 2). The combination of the noise current and the drive current operates to manipulate and/or broaden the spectrum of carrier signal 50.

In this embodiment, the noise current applied to the light source produces both amplitude modulation and phase modulation in the carrier signal. In most cases, the noise current generation by circuit 100 operates to broaden the line-width through phase modulation while causing an acceptable or minimal transmission penalty resulting from amplitude modulation. Accordingly, it may be advantageous to use a modulation format that maximizes the line-width broadening through phase modulation and minimizes transmission penalty due to amplitude modulation.

FIG. 4 is a graph comparing output spectrums of a light source when the light source is receiving a noise current from an SBS suppression circuit and when the light source is not receiving such noise current. The SBS suppression circuit can be substantially similar in structure and function to SBS suppression circuit 100 of FIGS. 2 and 3. In this example, line 202 represents the output spectrum of the light source when the light source receives a noise current from an SBS suppression circuit. Line 204 represents the output spectrum of the light source when the light source does not receive the noise current from the SBS suppression circuit. In this example, the horizontal axis represents a log scale of baseband signal frequency, while the vertical axis represents a magnitude of power for the optical signal.

In this particular embodiment, the light source comprises a continuous wave DFB laser. Although a continuous wave DFB laser is used in this example, any other light source may be used without departing from the scope of the present disclosure. In this example, the noise current received by the light source operates to broaden the spectrum of the light source (e.g., broaden the line-width of the light source). Moreover, the noise current operates to inject a frequency band 270 that is within spectrum 204. The frequency band 270 associated with the noise current comprises a frequency range in the lower frequency portion of the scale. In some cases, frequency band 270 can comprise, for example, a frequency below 100 kHz, 200 kHz, or any other appropriate location. This graph illustrates that the noise current received by the light source operates to broaden the output spectrum of the light source. Broadening the output spectrum of the light source can advantageously allow the optical source to communicate an output signal at a higher power level without encroaching upon the threshold power level associated with SBS.

FIG. 5 is a flow chart showing one example of a method 500 of broadening a line-width or signal spectrum of a light source by combining a noise current with a drive current. In one particular embodiment, the noise current may be generated by SBS suppression circuit 100 illustrated in FIGS. 2 or 3. In this example, method 500 begins at step 510 by generating a noise current using SBS suppression circuit 100. In one particular embodiment, the noise current comprises an AC current having a Gaussian distribution with a plurality of peaks and valleys. In that embodiment, SBS suppression circuit 100 includes a reverse biased p-n junction based noise generator 102 to generate a thermal noise and a variable resistor 108 capable of varying the amount or frequency of the noise current communicated from circuit 100. Although SBS circuit 100 includes a reverse biased p-n junction and variable resistor in this example, other devices may be included in circuit 100 without departing from the scope of the present disclosure.

In this particular embodiment, a light source driver (e.g., driver 90 of FIG. 2) operates to communicate a drive current to a light source (e.g., light source 80 of FIG. 2). The noise current and the drive current are combined at step 520. The combination of the noise current and the drive current operates to change the optical signal spectrum or line-width of light source 80. In some cases, the combination of the noise current and the drive current can operate to broaden the spectrum of the light source by, for example, 300 MHz or more.

In this example, the light source generates a carrier signal (e.g., carrier signal 50 of FIG. 2) using the combination of the noise current and drive current received by the light source at step 530. The Gaussian distribution of the noise current operates to manipulate the amount of current received by the light source. For example, the combination of the drive current and the noise current results in an increase to the amount of current received by the light source when SBS suppression circuit 100 generates a peak in the distribution of the noise current. Moreover, the combination of the drive current and the noise current results in a decrease to the amount of current received by the light source (e.g., relative to the peak scenario) when circuit 100 generates a valley in the distribution of the noise current. Thus, the noise current can operate to change the amount of current supplied to the light source and to create a noise component in carrier signal (e.g., carrier signal 50 of FIG. 2). The noise component, in turn, may broaden the line-width or signal spectrum and increase the threshold power level associated with the process.

Information may be modulated or encoded onto the carrier signal at step 540 for transmission through a communication link. Modulation may occur via utilization of a variety of modulators, for example, a lithium-niobate modulator (LiNbO3), an electro-absorption modulator, a gallium arsenide modulator, or any other modulator capable of encoding information onto the carrier signal. In some embodiments, the modulation may include, for example, an on/off keying (OOK) sequence, a a forward error correction sequence, or any other algorithm capable of improving the bit error rate of the communication system.

In some embodiments, the modulator may encode information onto the optical carrier signal at a rate of at least 9.5 gigabits per second. Other embodiments may have lower or higher rates. After modulation, the modulated optical signal (e.g., optical signal 15a) may be communicated at step 550 through a communication link. In various embodiments, the communications link comprises a link distance of up to 500 kilometers, 800 kilometers, 1200 kilometers, or more.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. An optical transmitter comprising:
a light source operable to generate an optical signal having one or more wavelengths, the optical signal comprising a signal spectrum having an upper band limit and a lower band limit; and
a stimulated Brillouin scattering (SBS) suppression circuit coupled to the light source and operable to communicate a noise current for receipt by the light source, the noise current operable to broaden the signal spectrum of the optical signal, wherein the light source operates to convert the noise current into a noise component of the signal spectrum that resides between the upper band limit and the lower band limit.

2. The transmitter of claim 1, wherein the light source is selected from the group consisting of a continuous wave distributed feedback laser, a semiconductor laser, and a solid state laser.

3. The transmitter of claim 1, wherein the SBS suppression circuit comprises a current modulation format capable of broadening the signal spectrum using at least phase modulation and amplitude modulation.

4. The transmitter of claim 1, wherein the noise component operates to broaden the signal spectrum by at least 300 MHz.

5. The system of claim 1, wherein the noise current comprises a Gaussian noise distribution.

6. The transmitter of claim 1, further comprising a modulator operable to encode information onto the optical signal generated by the light source.

7. The transmitter of claim 6, wherein the modulator is operable to encode a forward error correction sequence onto the optical signal.

8. The transmitter of claim 6, wherein the modulator is operable to encode an on/off keying sequence onto the optical signal.

9. The transmitter of claim 1, further comprising a current driver operable to generate a drive current for combination with the noise current, the noise current operable to fluctuate a power of the light source, wherein the fluctuating power of the light source operates to generate the noise component in the optical signal.

10. A method of broadening a line-width of an optical signal, the method comprising:
generating a noise current operable to broaden a signal spectrum of an optical signal;
combining the noise current and a drive current; and
generating an optical signal using the combination of the noise current and the drive current, the noise current operable to produce a noise component in the optical signal.

11. The method of claim 11, wherein the noise component operates to broaden the signal spectrum by at least 300 MHz.

12. The method of claim 10, wherein the optical signal comprises a spectrum having an upper band limit and a lower band limit, and wherein the noise component resides between the upper band limit and the lower band limit of the optical signal.

13. The method of claim 12, wherein the noise component comprises an upper band limit and a lower band limit, and wherein the upper band limit resides at approximately 100 kHz.

14. The method of claim 10, wherein the noise current produces a current modulation format capable of broadening the signal spectrum using at least phase modulation and amplitude modulation.

15. The method of claim 10, wherein at least a majority of the noise current operates to broaden the line-width through phase modulation.

16. A method of broadening a line-width of an optical signal, the method comprising:
generating an optical signal with a light source, the optical signal having one or more wavelengths, the optical signal comprising a signal spectrum having an upper band limit and a lower band limit;
communicating a noise current to the light source, the noise current operable to broaden the signal spectrum of the optical signal, wherein the light source operates to convert the noise current into a noise component of the signal spectrum that resides between the upper band limit and the lower band limit.

17. The method of claim 16, wherein the noise current produces a modulation format capable of broadening the signal spectrum using at least phase modulation and amplitude modulation.

18. The method of claim 16, wherein the noise component operates to broaden the signal spectrum by at least 300 MHz.

19. The method of claim 16, further comprising encoding information onto the optical signal generated by the light source, wherein encoding information onto the optical signal includes encoding at least one on/off keying sequence onto the optical signal.

20. The method of claim 16, further comprising:
generating a drive current;
combining the noise current and the drive current; and
generating the optical signal using the combination of the noise current and the drive current.
